(19) United States
(12) Patent Application Publication
(10) Pub. No.: US 2009/0028572 A1
(43) Pub. Date: Jan. 29, 2009

(54) FREE-SPACE OPTICAL RECEIVING APPARATUS AND ELECTRONIC DEVICE EQUIPPED WITH THAT APPARATUS

(76) Inventor: Nobuhisa WATANABE, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/168,523

(22) Filed: Jul. 7, 2008

(30) Foreign Application Priority Data
Jul. 27, 2007 (JP) 2007-196335

(51) Int. Cl. H04B 10/06

(52) U.S. Cl. 398/118

(57) ABSTRACT

A free-space optical receiving apparatus in one embodiment of the invention is provided with: a signal receiving light-sensitive element that converts an infrared signal to an electric current signal; a current-voltage conversion circuit that converts the electric current signal to a voltage signal; a shared processing circuit that amplifies this voltage signal, performs digital conversion on the voltage signal, and outputs a digital signal; and a mode conversion circuit that switches the shared processing circuit to a remote control mode when an infrared signal is received, and switches the shared processing circuit to an IrSimple mode when an IrSimple signal is received. The shared processing circuit converts the remote control signal to a digital signal when in the remote control mode, and converts the IrSimple signal to a digital signal when in the IrSimple mode.

### BACKGROUND OF THE INVENTION

This application claims priority under 35 U.S.C. § 119(a) on Japanese Patent Application No. 2007-196335 filed in Japan on Jun. 27, 2007, the entire contents of which are herein incorporated by reference.

The present invention relates to a free-space optical receiving apparatus and an electronic device equipped with that apparatus, in which when performing wireless communications using infrared signals, an infrared signal that indicates an IrSimple signal and a remote control signal is received, and this received infrared signal is converted to obtain a digital signal that expresses the IrSimple signal and the remote control signal.

Conventionally, free-space infrared communications are often used in order to perform wireless communications between different electronic devices. In free-space infrared communications, in bi-directional communications protocols established by the IrDa (Infrared Data Association), standards related to several layers are defined, such as for example a physical layer, a data link layer, a network layer, and a transport layer.

In free-space infrared communications in which these protocols are employed, it is not necessary to form a physical network between a sending device and a receiving device (a receiving apparatus), and peer-to-peer (1-on-1) communications can be established in a simple manner. At present, for example, such free-space infrared communications are being implemented between portable telephones or DSCs (digital still cameras) and printers.

As one conventional example of a signal processing circuit used to configure a receiving device used when implementing such free-space infrared communications, there is the signal processing circuit disclosed in JP 2006-140668A. This signal processing circuit is formed by adding a remote control signal processing circuit to an IrDA signal processing circuit. An IrDA signal processing circuit is a processing circuit that processes and outputs only signals (IrDA signals) used when implementing communications based on IrDA standards. A remote control signal processing circuit is a processing circuit that processes and outputs only signals (remote control signals) whose data transmission speed is outside of the range of the data transmission speed of IrDA signals, used for example when performing a remote control operation in order to switch television channels or adjust sound volume.

Also, in thin form factor televisions (TVs), which recently are in wide use and of which liquid crystal TVs and plasma TVs are representative, there is the problem that in dark rooms the black display portion of the screen appears gray, so the contrast ratio worsens. The reason for this problem is that, for example, in a liquid crystal TV, in a state in which a backlight is always lit from behind a display panel, screen display is performed by controlling whether the light of the backlight passes through the liquid crystal or is blocked by the liquid crystal, so in a dark room, leaking light cannot be ignored even if the light of the backlight is blocked by the liquid crystal.

In order to address such a problem, some liquid crystal TVs are provided with a function to automatically adjust the luminance of the backlight. As one conventional example of a control circuit that realizes this sort of function, there is the backlight dimming control circuit of a liquid crystal display apparatus disclosed in JP H9-146073A. The backlight dimming circuit of this liquid crystal display apparatus is provided with a plurality of light sensors (illuminance sensors) that detect illuminance around a liquid crystal display panel and output an external light illuminance signal with a level corresponding to the luminance of the detected light, an average value calculation means that calculates an average value of all or some of the external light illuminance signals output from the light sensors, and a luminance adjusting means that performs luminance adjustment of a backlight drive circuit based on the average value of the external light illuminance signals calculated with the average value calculation means and a manually set amount of dimming. This backlight dimming circuit automatically performs dimming according to the illuminance of outside ambient light and the individual visibility of an operator.

Recently, with the additional objective of further reducing the power consumption of the backlight by performing this sort of automatic dimming, it has become necessary to equip the receiving device of free-space infrared communications devices with an illuminance sensor.

On the other hand, the IrSimple 1.0 protocol (standards for high speed wireless communications using infrared, jointly developed by ITX E-Globaledge Corporation, NTT DoCoMo, Inc., Sharp Corporation and Waseda University), in which the above bi-directional communications protocols established by the IrDA are simplified and thus effective communication speeds are increased, was put into practice. Small and inexpensive free-space infrared communication devices using this IrSimple 1.0 protocol have been offered.

With this IrSimple protocol, the physical layer defined in the conventional IrDA standards is used as-is, and the protocols for the data link layer, the network layer, and the transport layer are simplified. Also, with the IrSimple protocol, two profiles have been formulated, namely a Home Appliance Profile (a unidirectional communications profile) that realizes unidirectional communications and a Tiny Object Exchange Profile (a bidirectional communications profile) for performing bi-directional communications.

The unidirectional communications profile was created with the objectives of brief operation and simple implementation. When performing communications using this protocol, the sending device continuously performs connection between the receiving device and the sending device, data conversion, and severing of the connection, and the receiving device only performs confirmation of whether or not data has been completely received. In a case where data has been completely received, based on control by a controller (an apparatus that, based on an output signal from the receiving device, for example, performs control of a display apparatus, a printer, a music playback apparatus, or the like) connected to the receiving device, processing is performed that displays received data on a display apparatus, prints received data with a printer, or the like. On the other hand, in a case where failed data reception is detected, communications are ended.

Receiving devices compatible with unidirectional communications employing the IrSimple 1.0 protocol are installed in video devices such as TVs or projectors, and for example, are used in applications in which, after image data captured with a portable telephone or a DSC is received with a receiving device compatible with unidirectional communications, that image data is transmitted to a TV, a projector, or the like. In this sort of application, a portable telephone or a DSC is used as a data sending device in a form such as a conventional remote control sending device, thus realizing high-speed communications. Also, some portable telephones or the like include a function as a remote control sending device and are used, for example, to change TV channels, the portable telephone thus being used as a substitute for a conventional remote control sending device.

However, although devices have been implemented in which it is possible to use the sending device for both IrSimple signals and remote control signals, there are no conventional devices in which the receiving device is provided with a shared processing circuit capable of processing both of these signals.

One example of an ordinary receiving device is shown in FIG. 7.

This receiving device is provided with a photodiode (PD) 100 that receives an infrared signal S that indicates an IrSimple signal and a remote control signal, and by outputting an electric current of a size proportional to the light quantity of the received infrared signal S, converts the IrSimple signal and the remote control signal from an infrared signal to an electrical signal; an I/V conversion circuit 101 that, because the current values of the electric signals output from the PD 100 are extremely weak, performs current-voltage conversion (I/V conversion) in order to express the IrSimple signal and the remote control signal, which are expressed as current values, as voltage values; an IrSimple processing circuit 102 that converts the IrSimple signal to a digital signal; a remote control processing circuit 103 that converts the remote control signal to a digital signal; and a selection circuit 104 that designates which processing circuit to operate of the IrSimple processing circuit 102 and the remote control processing circuit 103.

This receiving device is provided with an IrSimple output terminal 105 and a remote control output terminal 106 as external output terminals, and a selection input terminal 107 as an external input terminal. The IrSimple output terminal 105 is a terminal for taking a signal output from the IrSimple processing circuit 102 to the outside, and the remote control output terminal 106 is a terminal for taking a signal output from the remote control processing circuit 103 to the outside.

The selection circuit 104, based on the level of a selection signal that has been input via the selection input terminal 107, when a remote control signal is being received, switches the IrSimple processing circuit 102 to an off state, and switches the remote control processing circuit 103 to an on state. When an IrSimple signal is being received, the selection circuit 104 switches the IrSimple processing circuit 102 to an on state, and switches the remote control processing circuit 103 to an off state.

Because the processing circuit that processes IrSimple signals and the processing circuit that processes remote control signals are configured separately in a conventional receiving device, there is the problem of increased cost for the receiving device itself. Further, there is the problem that the system configuration is complicated for an electronic device configured from a receiving device, a controller, and various apparatuses controlled by this controller.

### SUMMARY OF THE INVENTION

The invention was made in view of the above conventional problems, and it is an object thereof to provide a free-space optical receiving apparatus and an electronic device equipped with this apparatus, in which due to processing IrSimple signals and remote control signals with the same processing circuit, the system configuration is simple and costs are low.

In order to address the above problems, the free-space optical receiving apparatus of the invention presumes a free-space optical receiving apparatus that receives infrared signals that express IrSimple signals and remote control signals, and by converting received infrared signals, obtains digital signals that express IrSimple signals and remote control signals. The free-space optical receiving apparatus includes: a signal receiving light-sensitive element that converts an infrared signal to an electric current signal; a current-voltage conversion circuit that converts the electric current signal to a voltage signal; a shared processing circuit that amplifies the voltage signal, performs digital conversion on the voltage signal, and outputs a digital signal; and a mode conversion circuit that switches the shared processing circuit to a remote control mode when an infrared signal that expresses a remote control signal is received, and switches the shared processing circuit to an IrSimple mode when an infrared signal that expresses an IrSimple signal is received. The shared processing circuit converts the remote control signal to a digital signal when in the remote control mode, and converts the IrSimple signal to a digital signal when in the IrSimple mode.

With the above configuration of the invention, conversion processing of IrSimple signals and remote control signals received by a receiving apparatus can be performed with the same processing circuit (a shared processing circuit), so it is possible to provide a free-space optical receiving apparatus in which the system configuration is simple and costs are low.

Also, a configuration may be adopted in which an IrSimple output terminal and a remote control output terminal serving as external output terminals are provided in the shared processing circuit, an IrSimple signal being output from the IrSimple output terminal and a remote control signal being output from the remote control output terminal.

In this case, it is possible to take out IrSimple signals and remote control signals from separate output terminals, so a free-space optical receiving apparatus and a controller can easily be connected.

Furthermore, a configuration may be adopted in which the IrSimple output terminal is connected to the shared processing circuit via a first switching element, and the remote control output terminal is connected to the shared processing circuit via a second switching element.

In the case of IrSimple signals, a physical layer defined by IrDA (Infrared Data Association Serial Infrared Physical Layer Specification) 1.0 to 1.4 is ordinarily used for communications. The standards defined in IrDa 1.0 to 1.4 are broadly divided into standards related to two communications modes, and these modes are distinguished by a difference in communications speed.

The first mode deals with low-speed communications using signals with a communications speed of up to 115.2 kbps, and is referred to as a Serial Infrared (SIR) mode. The second mode deals with high-speed communications using signals with a communications speed of 4.0 Mbps and a pulse width of 125 ns (duty ¼), and is referred to as a Fast Infrared (FIR) mode.

In this way, the communications speed and pulse width of signals is completely different between the SIR mode and the FIR mode, so when amplifying signals, two amplifiers that can deal with different bands are respectively necessary.

In the invention, image data, music data, or the like is sent from a sending device. When sending this sort of data, ordinarily an IrSimple signal in the FIR mode is used as the IrSimple signal that is output from the sending device. Thus, by using a first buffer circuit that has frequency characteristics in a band that includes the frequency band of IrSimple signals in the FIR mode as the first switching element, it is possible to allow the first buffer circuit to function as a switching element that outputs IrSimple signals in the FIR mode.

On the other hand, remote control signals ordinarily are signals with a subcarrier at a frequency of 30 to 60 kHz and duty cycle 50%, and that use a frequency band near the SIR mode of IrSimple signals, so in the invention, remote control signals are dealt with in the same way as SIR mode signals. Thus, by using a second buffer circuit that has frequency characteristics in a band that includes the frequency band of IrSimple signals in the SIR mode as the second switching element, it is possible to allow the second buffer circuit to function as a switching element that outputs digital signals that indicate remote control signals.

Note that in the invention, the “SIR mode” is also referred to as the “remote control mode”, and the “FIR mode” is also referred to as the “IrSimple mode”.

Furthermore, a buffer switching means may be provided that, when an IrSimple signal is being received, switches the second buffer circuit to an off state, and when a remote control signal is being received, switches the first buffer circuit to an off state.

In this case, it is possible to more reliably reduce the effect of a controller connected to the IrSimple output terminal on the remote control output terminal, and the effect of a controller connected to the remote control output terminal on the IrSimple output terminal, and it is also possible to suppress power consumption of the free-space optical receiving apparatus.

Also, an illuminance detection means that detects the light quantity of outside ambient light may be provided, the illuminance detection means having an illuminance detection light-sensitive element that outputs a current signal that expresses a sum of the light quantity of outside ambient light and the light quantity of an infrared signal.

In this case, in one free-space optical receiving apparatus, it is possible to realize an infrared signal processing means that receives an infrared signal that expresses an IrSimple signal and a remote control signal and converts this received infrared signal to a digital signal, and an illuminance sensor that measures the amount of outside ambient light. Also, because only infrared signals are received by the infrared signal processing means, it is possible to separately process infrared signals and the outside ambient light without mixing those signals, so precise signal processing can be performed.

Also, a configuration may be adopted in which the shared processing circuit is provided with a communications amplifier as a means of amplifying a voltage signal output from a current-voltage conversion circuit, and an automatic gain control (AGC) circuit, and the illuminance detection means is provided with an illuminance detection amplifier that amplifies a current signal output from the illuminance detection light-sensitive element, and the automatic gain control circuit adjusts the amplification factor of the communications amplifier according to a change in the output signal of the illuminance detection amplifier.

In this case, the change in the current value of the current signal output from the illuminance detection amplifier can be fed back to the amplification factor of the communications amplifier, so it is possible to simplify the circuit configuration of the infrared signal processing means, and thus possible to provide a still lower cost free-space optical receiving apparatus.

The illuminance detection means may further be provided with a shut-down circuit that shuts down output from the illuminance detection means when an IrSimple signal or a remote control signal is being received.

In this case, it is possible to prevent the illuminance detection means from receiving an IrSimple signal or a remote control signal and causing an erroneous operation, and when receiving an IrSimple signal or a remote control signal, there is almost no current consumption by the illuminance detection means, so it is possible to suppress the power consumption of the free-space optical receiving apparatus.

Also, the output signal of the illuminance detection means may be an analog signal that changes in linear proportion to the total light quantity of outside ambient light and the infrared signal incident at the illuminance detection light-sensitive element.

In this case, it is possible to simply establish a one-to-one association of the degree of illuminance of outside ambient light and the output of the illuminance sensor, which is the output from the illuminance detection means. As a result, it is possible to perform high-precision illuminance measurement.

Also, a configuration may be adopted in which the illuminance detection means is further provided with an analog to digital (A/D) converter, and the output signal of the illuminance detection means is a digital signal.

In this case it is possible to directly connect the free-space optical receiving apparatus and the controller, without passing through an A/D converter.

The electronic device of the invention is equipped with the free-space optical receiving apparatus described above. With this configuration, it is possible to realize an electronic device in which the system configuration is simple and costs are low.

### BRIEF DESCRIPTION OF THE DRAWINGS

FIG. 1 is a block diagram that shows Embodiment 1 of a free-space optical receiving apparatus of the invention.

FIG. 2 is a block diagram that shows an example of a shared processing circuit used to configure the free-space optical receiving apparatus shown in FIG. 1.

FIG. 3 is a block diagram that shows Embodiment 2 of the free-space optical receiving apparatus of the invention.

FIG. 4 is a block diagram that shows an example of a shared processing circuit used to configure the free-space optical receiving apparatus shown in FIG. 3.

FIG. 5 is an explanatory cross-sectional view that shows a specific example of a package of the free-space optical receiving apparatus of Embodiment 2.

FIG. 6 is a block diagram that shows Embodiment 3 of the free-space optical receiving apparatus of the invention.

FIG. 7 is a block diagram that shows an example of a conventional receiving device.

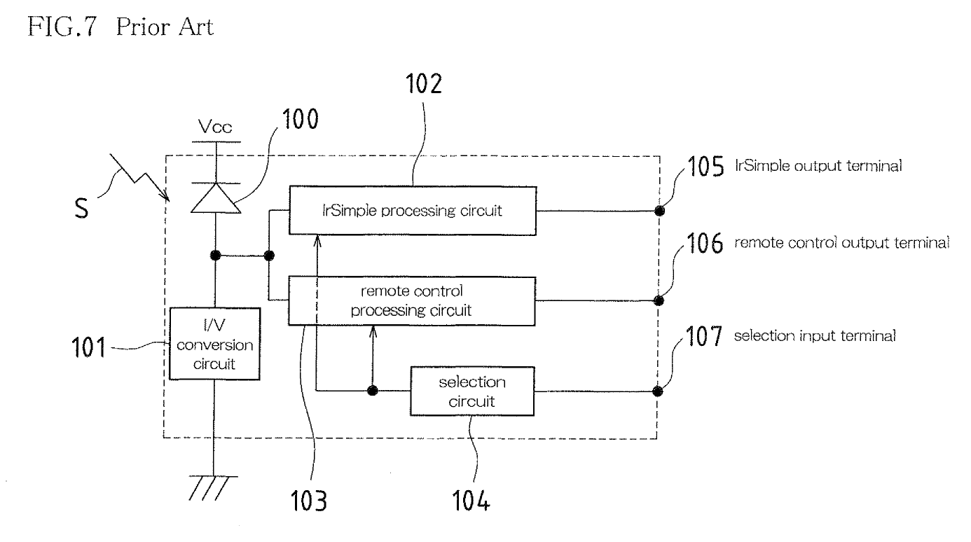

### DESCRIPTION OF THE PREFERRED EMBODIMENTS

Hereinafter, embodiments of the invention will be described with reference to the accompanying drawings.

### Embodiment 1

First, Embodiment 1 of the free-space optical receiving apparatus of the invention will be described with reference to the accompanying drawings.

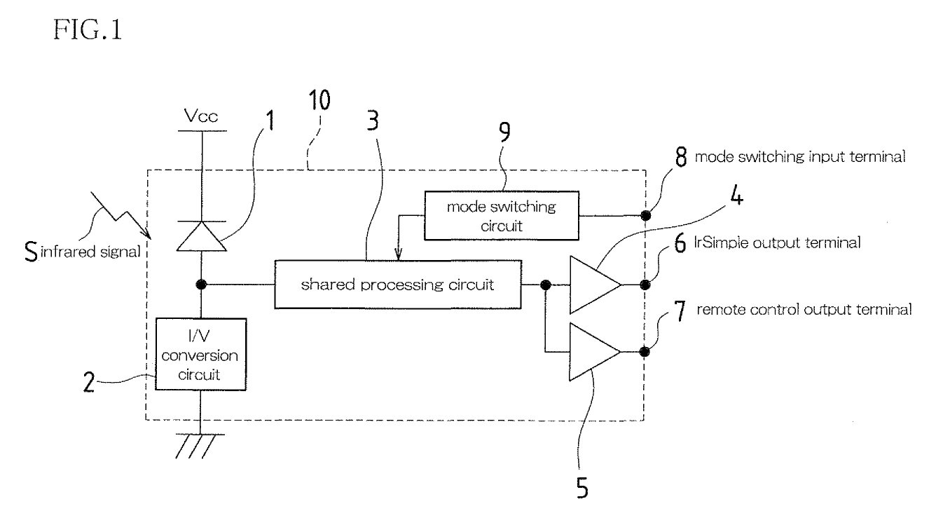

FIG. 1 is a block diagram that shows Embodiment 1 of the free-space optical receiving apparatus of the invention.

A free-space optical receiving apparatus 10 is provided with, broadly classified, a signal receiving PD 1, an I/V conversion circuit 2, a shared processing circuit 3, a first buffer circuit 4, a second buffer circuit 5, an IrSimple output terminal 6 and a remote control output terminal 7 serving as external output terminals, a mode switching input terminal 8 serving as an external input terminal, and a mode switching circuit 9.

The single receiving PD 1 receives an infrared signal S that expresses an IrSimple signal or a remote control signal, and outputs electric current of a size proportional to the light quantity of this received signal.

The IV conversion circuit 2, because the current output from the signal receiving PD 1 is extremely weak, performs current-voltage conversion in order to express an IrSimple signal or a remote control signal, which is expressed as a current value, as a voltage value.

The shared processing circuit 3 performs processing that converts an IrSimple signal or a remote control signal, after current-voltage conversion, to a digital signal.

The first buffer circuit 4 has frequency characteristics in a band that includes the frequency band of IrSimple signals in the IrSimple mode, and is a switching element that selectively outputs an IrSimple signal in the IrSimple mode that has been output from the shared processing circuit 3. On the other hand, the second buffer circuit 5 has frequency characteristics in a band that includes the frequency band of IrSimple signals in the remote control mode, and is a switching element that selectively outputs a remote control signal that has been output from the shared processing circuit 3.

The IrSimple output terminal 6 is connected to the first buffer circuit 4, and the remote control output terminal 7 is connected to the second buffer circuit 5.

A mode switching signal that controls operation of the mode switching circuit 9 is input to the mode switching input terminal 8. The mode switching circuit 9 switches the mode of the shared processing circuit 3 according to this mode switching signal.

Also, ordinarily, various circuits used to configure a controller have various impedances depending on the specifications of the circuits, so a problem may occur in which the IrSimple output terminal 6 and the remote control output terminal 7 interact with each other due to an impedance difference. In order to address such a problem, in this embodiment, it is preferable to provide a buffer switching means that, when an IrSimple signal is being received, switches the second buffer circuit 5 to an off state, and when a remote control signal is being received, switches the first buffer circuit 4 to an off state. Also, it is preferable that this buffer switching circuit operates together with the mode switching circuit.

Furthermore, by providing this sort of buffer switching means, it is possible to switch either one of the buffer circuits to an off state, and almost no current will flow to the buffer circuit that has been switched to the off state, so it thus possible to suppress power consumption of the free-space optical receiving apparatus.

Also, it is preferable that in the free-space optical receiving apparatus of the invention, as in this embodiment, the output terminals of the free-space optical receiving apparatus are in two forms. That is, it is preferable that the IrSimple output terminal 6 for outputting IrSimple signals and the remote control output terminal 7 for outputting remote control signals are provided divided from each other as the output terminals of the free-space optical receiving apparatus. With this sort of configuration, it is possible to separately take out IrSimple signals and remote control signals from the free-space optical receiving apparatus.

As a result, a connection between a controller (not shown) and the free-space optical receiving apparatus can be realized with simple work, in which an IrSimple input terminal (a terminal where IrSimple signals are input) of the controller is connected to the IrSimple output terminal 6 via a predetermined cable, and a remote control input terminal (a terminal where remote control signals are input) of the controller is connected to the remote control output terminal 7 via a cable.

Next is a more detailed description of the shared processing circuit used to configure the free-space optical receiving apparatus shown in FIG. 1, with reference to the drawings.

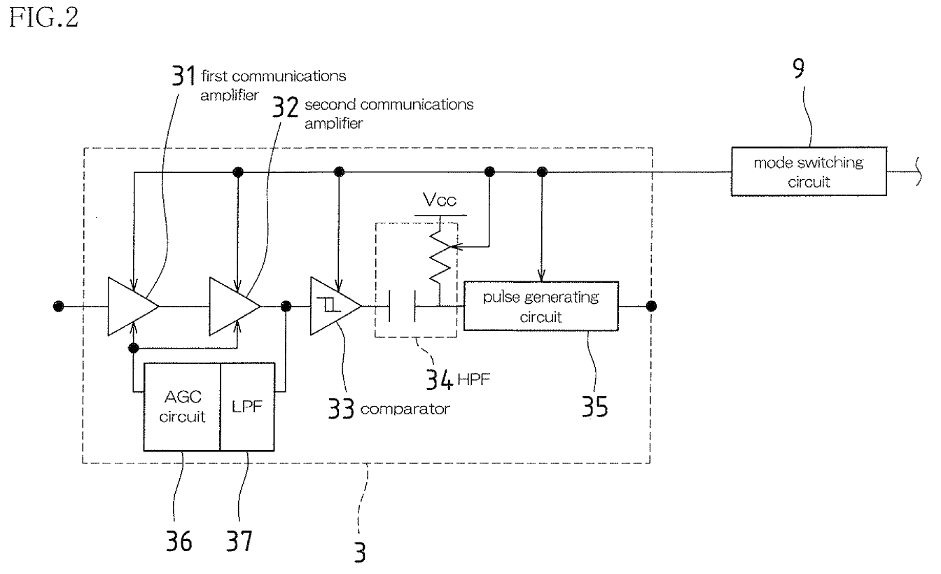

FIG. 2 is a block diagram that shows an example of a shared processing circuit used to configure the free-space optical receiving apparatus shown in FIG. 1.

This shared processing circuit 3 is configured from, broadly classified, a first communications amplifier 31 and a second communications amplifier 32 that are dependently connected in two stages, a comparator 33, an HPF (High Pass Filter) 34, a pulse generating circuit 35, an AGC circuit 36, and an LPF 37.

When a remote control signal is being received, the mode switching circuit 9 switches the first communications amplifier 31, the second communications amplifier 32, the comparator 33, the HPF 34, and the pulse generating circuit 35 to the remote control mode, and thus causes the shared processing circuit to operate in the remote control mode, in which IrSimple signals in the SIR mode are processed. On the other hand, when an IrSimple signal is being received, the mode switching circuit 9 switches the first communications amplifier 31, the second communications amplifier 32, the comparator 33, the HPF 34, and the pulse generating circuit 35 to the IrSimple mode, and thus causes the shared processing circuit to operate in the IrSimple mode, in which IrSimple signals in the FIR mode are processed.

Specifically, in the remote control mode, both the first communications amplifier 31 and the second communications amplifier 32 have a minimum band in which it is possible to amplify a signal having a communications speed of 115.2 kbps and a duty cycle of 3/16, a rising edge is detected with the HPF 34, and a pulse signal with a pulse width of 1.63 μs and a duty cycle of 3/16 is generated by the pulse generation circuit. On the other hand, in the IsSimple mode, both the first communications amplifier 31 and the second communications amplifier 32 have a minimum band in which it is possible to amplify a signal having a communications speed of 4 Mbps and a duty cycle of ¼, a rising edge is detected with the HPF 34, and a pulse signal with a pulse width of 125 ns (a duty cycle of ¼) is generated by the pulse generating circuit 35.

First, the first communications amplifier 31 and the second communications amplifier 32 amplify a voltage signal obtained by conversion processing performed by the I/V conversion circuit 2 shown in FIG. 1.

Note that the amplification factor of the first communications amplifier 31 and the second communications amplifier 32 is controlled by the AGC circuit 36. Ordinarily, IrSimple signals and remote control signals are output from a sending device built into a mobile device or a hand-held type of device, so the distance between these devices and the free-space optical receiving apparatus may change at any time. As the distance between the sending device and the free-space optical receiving apparatus increases with these changes, the dynamic range of the signal receiving PD 1 is reduced. When the dynamic range is reduced, the problems occur that audio range is reduced in a case where the infrared signal is a signal that expresses audio data, and an unclear screen is displayed in a case where the infrared signal is a signal that expresses image data. In order to eliminate such problems, the AGC circuit 36, according to a value obtained by time-averaging the signal output from the second communications amplifier 32 in the LPF 37, drives the first communications amplifier 31 and the second communications amplifier 32 at a low amplification factor in a case where much light is received by the signal receiving PD 1, and runs the first communications amplifier 31 and the second communications amplifier 32 at a high amplification factor in a case where little light is received by the signal receiving PD 1. Thus the AGO circuit 36 adjusts the gain of these amplifiers.

Next, the signal amplified by the first communications amplifier 31 and the second communications amplifier 32 is converted to a digital signal by the comparator 33, a low frequency component is removed by the HPF 34, the signal is converted to a pulse signal with a pulse width appropriate for signal processing performed afterward by the pulse generating circuit 35, and then the signal is output from the shared processing circuit 3. That is, in the shared processing circuit 3, an analog signal, with an alternating current waveform whose current value continuously changes based on the light quantity of the infrared signal received by the signal receiving PD 1, is converted to a digital signal.

Note that the mode switching signal is a signal input from outside of the free-space optical receiving apparatus, and indicates that a particular operation occurred, when for example an operator used a sending device to perform an operation indicating to send an IrSimple signal, or when an operator used a controller connected to the free-space optical receiving apparatus to perform an operation of receiving an IrSimple signal. Usually, the mode switching circuit causes the shared processing circuit 3 to operate in the remote control mode, according to the mode switching signal. The mode switching circuit only switches modes to cause the shared processing circuit 3 to operate in the IrSimple mode when an operation like those described above has occurred. Afterward, if the free-space optical receiving apparatus has not received an IrSimple signal even after passage of a length of time that has been set in advance, or if receiving of an IrSimple signal has been interrupted for a length of time that has been set in advance, the mode switching circuit 9 automatically switches modes to cause the shared processing circuit 3 to operate in the remote control mode.

### Embodiment 2

Next is a description of Embodiment 2 of the free-space optical receiving apparatus of the invention, with reference to the drawings.

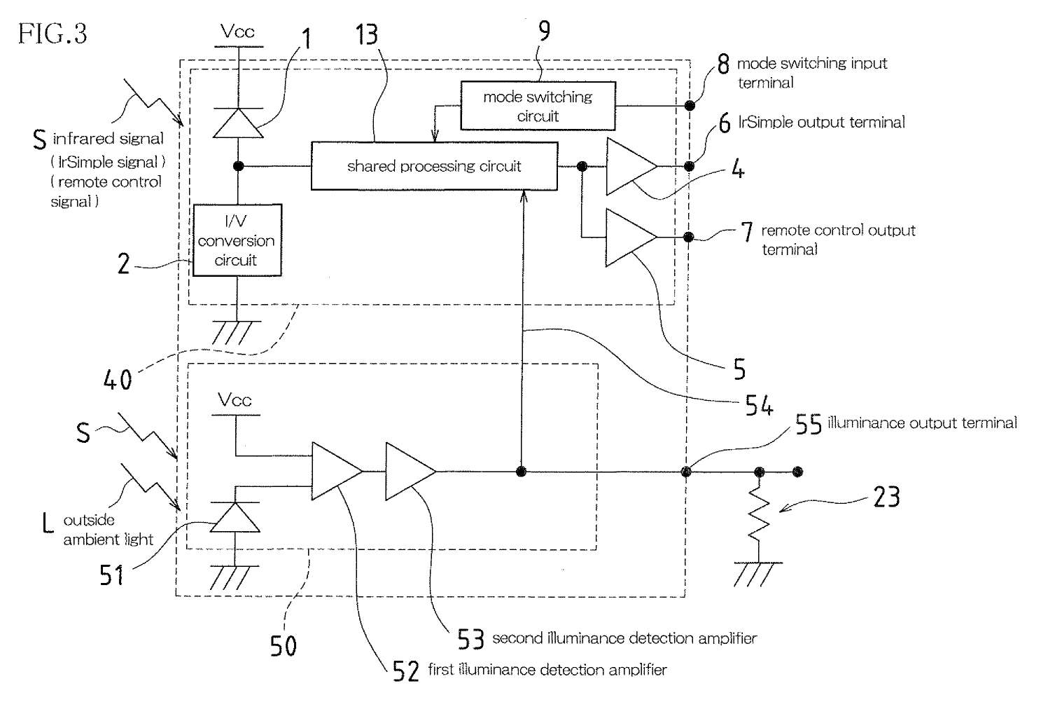

FIG. 3 is a block diagram that shows Embodiment 2 of the free-space optical receiving apparatus of the invention.

The free-space optical receiving apparatus of this embodiment is configured from an infrared signal processing means 40 that has approximately the same configuration and operates in the same manner as the free-space optical receiving apparatus 10 of Embodiment 1 described above, and an illuminance detection means 50 that outputs an illuminance signal.

The illuminance detection means 50, as shown in FIG. 3, is configured from an illuminance detection PD 51, a first illuminance detection amplifier 52, a second illuminance detection amplifier 53, wiring 54 that connects an output terminal of the second illuminance detection amplifier 53 to a shared processing circuit 13, and an illuminance output terminal 55 that is an external output terminal of the free-space optical receiving apparatus.

In the illuminance detection means 50, first, the illuminance detection PD 51 outputs a current signal that expresses an average value of the sum of the light quantity of an incident infrared signal S and the light quantity of outside ambient light L, and next, by sequentially amplifying this signal with the first illuminance detection amplifier 52 and the second illuminance detection amplifier 53, an illuminance signal is obtained, and the illuminance signal is taken outside via the illuminance output terminal 55.

If this illuminance signal is used when controlling operation of a backlight drive circuit of a liquid crystal display apparatus, it is possible to cause the illuminance detection means 50 to function as an illuminance sensor that automatically adjusts the luminance of the backlight according to the brightness of the outside ambient light L.

Usually, a PD with a peak wavelength of 550 to 560 nm is used as the light-sensitive element of an illuminance sensor. This peak wavelength is the center value of the spectrum of light visible to humans (wavelengths of approximately 400 to 700 nm), and by using a PD with such a peak wavelength, it is possible to automatically adjust the luminance of the backlight according to human visibility. In this embodiment, as the illuminance detection PD 51 that serves as the light-sensitive element of an illuminance sensor, a PD is used that is also sensitive in the infrared region, and is a relatively low cost PD formed using Si. By using this sort of PD, in the illuminance detection PD 51 it is possible to obtain a current signal that expresses a light quantity including not only the outside ambient light L but also the light quantity of the infrared signal S.

In this illuminance detection means 50, with respect to IrSimple signals and remote control signals, it is sufficient that an average value can be measured at each instance of a length of time that has been set in advance, so a PD or an amplifier that can process a low frequency band component (for example, a frequency of tens of Hertz to several 10 k Hertz) is used as the illuminance detection PD 51, the first illuminance detection amplifier 52, and the second illuminance detection amplifier 53.

Note that it is not preferable to use a PD or an amplifier having frequency characteristics in a high frequency range as the illuminance detection PD 51, the first illuminance detection amplifier 52, and the second illuminance detection amplifier 53. Recently, because inverter-type fluorescent lights are being widely used as interior lighting, when a PD or an amplifier having frequency characteristics in a high frequency range near the frequency of electric current when this inverter-type fluorescent light is turned on, there is a reaction with the frequency of electric current when this inverter-type fluorescent light is turned on, and the output of the illuminance detection PD 51, the first illuminance detection amplifier 52, and the second illuminance detection amplifier 53 becomes unstable.

Also, although not shown, a log amplifier may be inserted between the second illuminance detection amplifier 53 and the illuminance output terminal 55, and in this case, it is possible to cause the illuminance detection means 50 to function as an illuminance sensor having log output properties.

Note that, as shown in FIG. 3, when the signal output from the second illuminance detection amplifier 53 has been taken out as-is from the illuminance output terminal 55, an analog signal is output from the illuminance output terminal 55. Accordingly, in a case where a controller that requires input of an analog signal is connected in a later stage, it is preferable to directly connect the illuminance output terminal 55 and the controller input terminal with wiring. On the other hand, in a case where a controller that requires input of a digital signal is connected, it is preferable to insert an A/D converter between the illuminance output terminal 55 and the controller input terminal.

Also, although not shown, in the case of a configuration in which an A/D converter is inserted between the second illuminance detection amplifier 53 and the illuminance output terminal 55, and a digital signal is taken out from the illuminance output terminal 55, it is possible to cause the illuminance detection means 50 to function as an illuminance sensor that outputs digital signals. In this case it is possible for the illuminance output terminal 55 and the input terminal of a controller that requires input of a digital signal to be directly connected with wiring, without inserting an A/D converter.

Note that in the case of the signal being output as current, in consideration of matching with a controller of a later stage, a resistor 23 for converting the current to voltage may be connected to the illuminance output terminal 55.

In this embodiment, as shown in FIG. 3, the output terminal of the second illuminance detection amplifier 53 is connected to the shared processing circuit 13 of the infrared signal processing means 40 via the wiring 54.

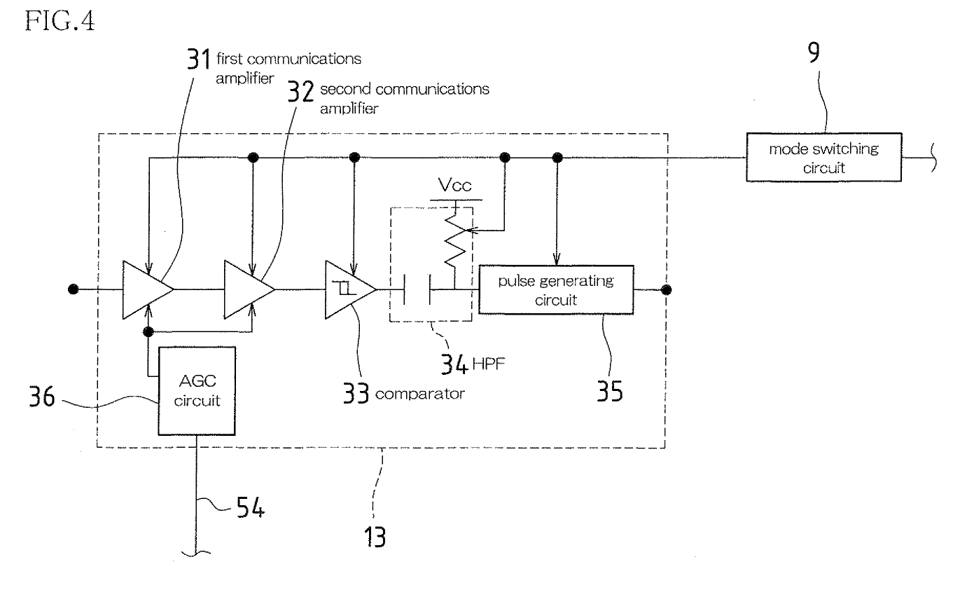

FIG. 4 is a block diagram that shows an example of a shared processing circuit of the infrared signal processing means 40 used to configure the free-space optical receiving apparatus shown in FIG. 3

The share processing circuit 13 shown in FIG. 3 differs from the shared processing circuit 13 shown in FIG. 2 in that an LPF is not provided, and the wiring 54 is connected to an AGC circuit 36.

As described above, as the illuminance detection PD 51, a PD is used that is also sensitive in the infrared region, and is a relatively low cost PD formed using Si. Therefore, a current signal that expresses a light quantity including not only the outside ambient light but also the light quantity of the infrared signal S is output from the illuminance detection PD 51. Accordingly, when the free-space optical receiving apparatus is receiving an infrared signal that expresses an IrSimple signal and a remote control signal, the signal output from the second illuminance detection amplifier 53 changes also according to the light quantity of the infrared signal S incident at the illuminance detection PD 51.

In Embodiment 1, the AGC circuit 36 controlled the amplification factor of the first communications amplifier 31 and the second communications amplifier 32 according to the change in the signal output from the LPF 37 shown in FIG. 2, but in this embodiment, the signal output from the second illuminance detection amplifier 53 is input to the AGC circuit 36 via the wiring 54, and the AGC circuit 36 controls the amplification factor of the first communications amplifier 31 and the second communications amplifier 32 according to the change in this signal.

According to the free-space optical receiving apparatus of this embodiment, it is possible to omit the LPF for shared processing, so it is possible to further simplify the circuit configuration of the shared processing circuit 13.

Next is a description of a specific example of a package of the free-space optical receiving apparatus of this embodiment, with reference to the drawings.

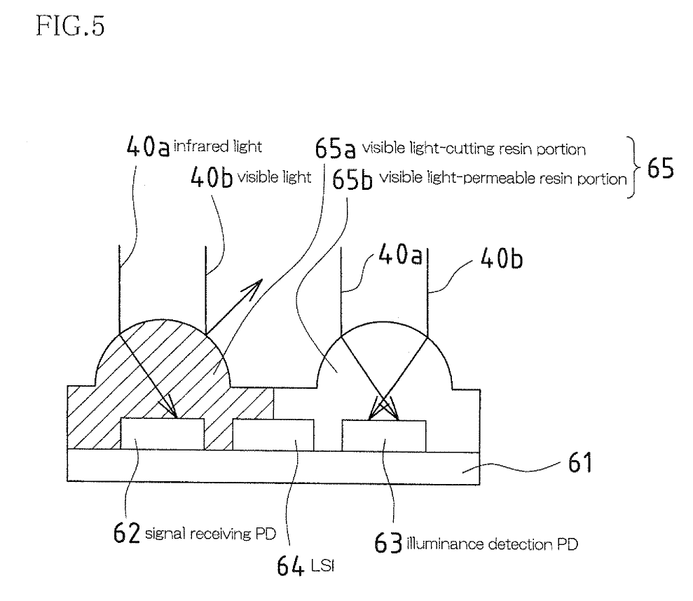

FIG. 5 is an explanatory cross-sectional view that shows a specific example of a package of the free-space optical receiving apparatus of this embodiment.

The free-space optical receiving apparatus is configured from a substrate 61, a signal receiving PD 62 disposed on the upper face of the substrate 61, an illuminance detection PD 63, an LSI (Large Scale Integration) 64, and a resin portion 65 that covers the surface of the signal receiving PD 62, the illuminance detection PD 63, and the LSI 64. The signal receiving PD 62 and the illuminance detection PD 63 are disposed in a state separated from each other, and the LSI 64 is disposed between the signal receiving PD 62 and the illuminance detection PD 63.

Ordinarily, to a PD provided in order to sense an infrared light 40a that expresses IrSimple signals and remote control signals, a visible light 40b is noise, and when the visible light 40b is also incident along with the infrared light 40a, the S/N (signal-to-noise) ratio of the PD deteriorates. Thus, in the resin portion 65, a portion 65a (indicated by a diagonal line in FIG. 5) that covers the signal receiving PD 62 is formed with visible light-cutting resin that blocks visible light. On the other hand, a portion 65b that covers the illuminance detection PD 63 is formed with visible light-permeable resin that is permeable by both the visible light 40b and the infrared light 40a, such that it is possible to receive both infrared signals and remote control signals with the illuminance detection PD 63.

Also, the resin portion 65, in order to collect the infrared light 40a at the signal receiving PD 62, is formed so that the upper portion of the signal receiving PD 62 is in the shape of a convex lens, and in order to collect the infrared light 40a and the visible light 40b at the illuminance detection PD 63, is formed so that the upper portion of the illuminance detection PD 63 is in the shape of a convex lens.

The LSI 64 is an integrated circuit that realizes an I/V conversion circuit 2, the shared processing circuit 13, a first buffer circuit 4, a second buffer circuit 5, the first illuminance detection amplifier 52, and the second illuminance detection amplifier 53, as shown in FIG. 3.

### Embodiment 3

Next is a description of Embodiment 3 of the free-space optical receiving apparatus of the invention, with reference to the drawings.

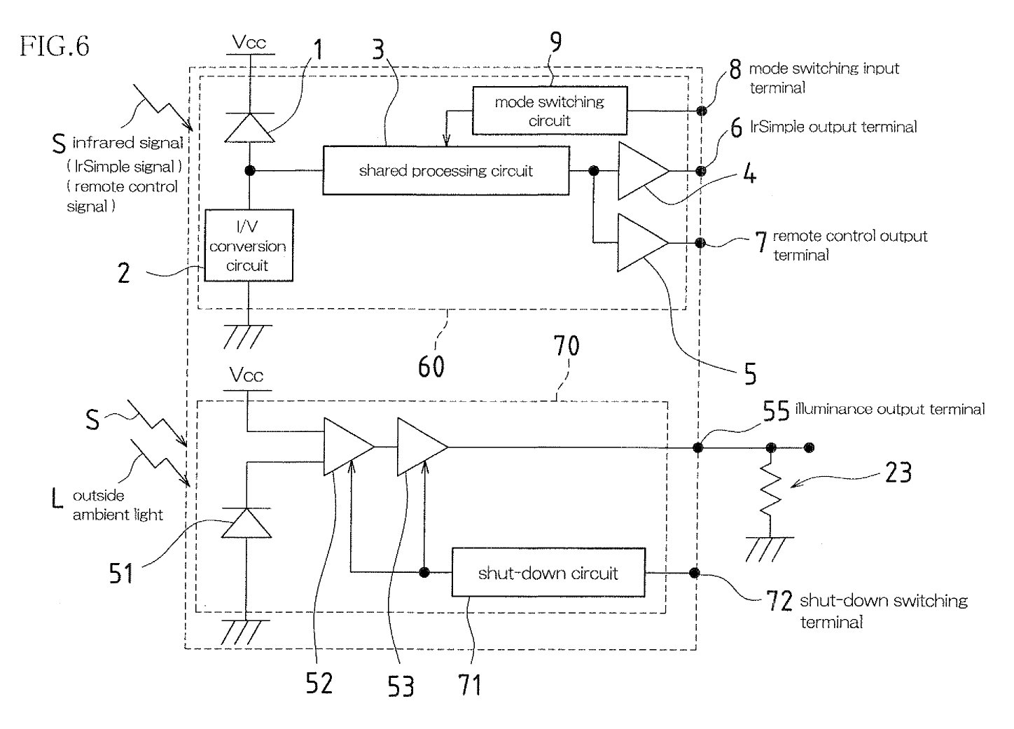

FIG. 6 is a block diagram that shows Embodiment 3 of the free-space optical receiving apparatus of the invention.

The free-space optical receiving apparatus of this embodiment is configured from an infrared signal processing means 60 that has the same configuration as the free-space optical receiving apparatus 10 of Embodiment 1 described above, and an illuminance detection means 70 provided with a shut-down circuit 71.

The illuminance detection means 70, as shown in FIG. 6, is configured from an illuminance detection PD 51, a first illuminance detection amplifier 52, a second illuminance detection amplifier 53, an illuminance output terminal 55 that is an external output terminal of the free-space optical receiving apparatus, the shut-down circuit 71, and a shut-down switching terminal 72 that serves as an external input terminal of the free-space optical receiving apparatus. Here, the illuminance detection PD 51, the first illuminance detection amplifier 52, the second illuminance detection amplifier 53, and the illuminance output terminal 55 have the same operation and function as those used to configure the illuminance detection means 50 shown in FIG. 3, so a description thereof is omitted; the shut-down circuit 71 and the shut-down switching terminal 72 will be described.

As described in Embodiment 2 above, a PD formed using Si is used as the illuminance detection PD 51, and this PD is also sensitive to light in the infrared region. Therefore, an illuminance signal output from the illuminance output terminal 55 changes not only according to changes in the light quantity of the outside ambient light L, but also according to whether or not infrared light (an infrared signal S) that expresses an IrSimple signal or a remote control signal is incident at the illuminance detection PD 51. When an IrSimple signal or a remote control signal is incident, the output of the illuminance detection PD 51 does not reflect the original outside ambient light.

In this embodiment, when a shut-down switching signal is input to the shut-down circuit 71 via the shut-down switching terminal 72, the first illuminance detection amplifier 52 and the second illuminance detection amplifier 53 are switched to the off state, and thus the illuminance detection means 70 enters a shut-down state. Note that the output of the illuminance output terminal 55 in the shut-down state may be a low level signal, or may be a signal that holds the level immediately before the shut-down state was entered.

A shut-down switching signal is input to the shut-down circuit 71 when, for example, an IrSimple controller (a controller that controls various apparatuses according to IrSimple signals) connected to an IrSimple output terminal has received an IrSimple signal, or when a remote control controller (a controller that controls various apparatuses according to remote control signals) connected to a remote control output terminal has received a remote control signal.

Furthermore, in this embodiment as well, same as in Embodiment 2, an analog signal may be taken out from the illuminance output terminal 55, or, although not shown, in a case where a controller that requires input of a digital signal is connected, an A/D converter may be inserted between the illuminance output terminal 55 and the controller input terminal. Also, a configuration may be adopted in which an A/D converter is inserted between the second illuminance detection amplifier 53 and the illuminance output terminal 55, and a digital signal is taken out from the illuminance output terminal 55.

Note that a resistor 23 as described above for converting current to voltage may be connected to the illuminance output terminal 55.

Also, the electronic device of the invention is configured from a free-space optical receiving apparatus as described above, a controller, and various apparatuses controlled by this controller (for example, such as a thin form factor television, a projector, a display apparatus, or a printer).

Furthermore, in this specification, operation when an IrSimple signal in the FIR mode is received and operation when a remote control signal is received are described in detail, but when the free-space optical receiving apparatus of the invention has received an IrSimple signal in the SIR mode, because the frequency band is similar for an IrSimple signal in SIR mode and a remote control signal, by performing the same sort of operation as when a remote control signal is received, an electrical signal that expresses an IrSimple signal in the SIR mode is output from the remote control output terminal.

A free-space optical receiving apparatus of the invention and an electronic device equipped with that apparatus are applicable in a case where wireless communications are performed selectively using both IrSimple signals and remote control signals.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A free-space optical receiving apparatus that receives infrared signals that express IrSimple signals and remote control signals, and by converting received infrared signals, obtains digital signals that express IrSimple signals and remote control signals, the apparatus comprising:
a signal receiving light-sensitive element that converts an infrared signal to an electric current signal;
a current-voltage conversion circuit that converts the electric current signal to a voltage signal;
a shared processing circuit that amplifies the voltage signal, performs digital conversion on the voltage signal, and outputs a digital signal; and
a mode conversion circuit that switches the shared processing circuit to a remote control mode when an infrared signal that expresses a remote control signal is received, and switches the shared processing circuit to an IrSimple mode when an infrared signal that expresses an IrSimple signal is received;
wherein the shared processing circuit converts the remote control signal to a digital signal when in the remote control mode, and converts the IrSimple signal to a digital signal when in the IrSimple mode.

2. The free-space optical receiving apparatus according to claim 1, wherein an IrSimple output terminal and a remote control output terminal serving as external output terminals are provided in the shared processing circuit, an IrSimple signal being output from the IrSimple output terminal and a remote control signal being output from the remote control output terminal.

3. The free-space optical receiving apparatus according to claim 2, wherein the IrSimple output terminal is connected to the shared processing circuit via a first switching element, and the remote control output terminal is connected to the shared processing circuit via a second switching element.

4. The free-space optical receiving apparatus according to claim 3, wherein the first switching element is a first buffer circuit that has frequency characteristics in a band that includes the frequency band of an IrSimple signal, and the second switching element is a second buffer circuit that has frequency characteristics in a band that includes the frequency band of a remote control signal.

5. The free-space optical receiving apparatus according to claim 4, comprising a buffer switching means that, when an IrSimple signal is being received, switches the second buffer circuit to an off state, and when a remote control signal is being received, switches the first buffer circuit to an off state.

6. The free-space optical receiving apparatus according to claim 1, further comprising an illuminance detection means that detects the light quantity of outside ambient light, the illuminance detection means having an illuminance detection light-sensitive element that outputs a current signal that expresses a sum of the light quantity of outside ambient light and the light quantity of an infrared signal.

7. The free-space optical receiving apparatus according to claim 6, wherein the shared processing circuit is provided with a communications amplifier that amplifies a voltage signal output from a current-voltage conversion circuit, and an automatic gain control circuit, and the illuminance detection means is provided with an illuminance detection amplifier that amplifies a current signal output from the illuminance detection light-sensitive element, and the automatic gain control circuit adjusts the amplification factor of the communications amplifier according to a change in the output signal of the illuminance detection amplifier.

8. The free-space optical receiving apparatus according to claim 6, wherein the illuminance detection means is further provided with a shut-down circuit that shuts down output from the illuminance detection means when an infrared signal is being received.

9. The free-space optical receiving apparatus according to claim 6, wherein the output signal of the illuminance detection means is an analog signal that changes in linear proportion to the total light quantity of outside ambient light and the infrared signal incident at the illuminance detection light-sensitive element.

10. The free-space optical receiving apparatus according to claim 7, wherein the output signal of the illuminance detection means is an analog signal that changes in linear proportion to the total light quantity of outside ambient light and the infrared signal incident at the illuminance detection light-sensitive element.

11. The free-space optical receiving apparatus according to claim 8, wherein the output signal of the illuminance detection means is an analog signal that changes in linear proportion to the total light quantity of outside ambient light and the infrared signal incident at the illuminance detection light-sensitive element.

12. The free-space optical receiving apparatus according to claim 6, wherein the illuminance detection means is further provided with an analog/digital converter, and the output signal of the illuminance detection means is a digital signal.

13. The free-space optical receiving apparatus according to claim 7, wherein the illuminance detection means is further provided with an analog/digital converter, and the output signal of the illuminance detection means is a digital signal.

14. The free-space optical receiving apparatus according to claim 8, wherein the illuminance detection means is further provided with an analog/digital converter, and the output signal of the illuminance detection means is a digital signal.

15. An electronic device equipped with the free-space optical receiving apparatus according to claim 1.
